(19) United States
(12) Patent Application Publication
(10) Pub. No.: US 2021/0012153 A1
(43) Pub. Date: Jan. 14, 2021

(54) IMAGE PROCESSING METHOD AND APPARATUS, ELECTRONIC DEVICE, AND STORAGE MEDIUM

(71) Applicants: Beijing BOE Optoelectronics Technology Co., Ltd.; BOE TECHNOLOGY GROUP CO., LTD., Beijing (CN)

(72) Inventors: Fuqiang Ma, Beijing (CN); Guixin Yan, Beijing (CN); Zehua Dong, Beijing (CN)

(21) Appl. No.: 16/498,145

(22) PCT Filed: Jan. 15, 2019
(86) PCT No.: PCT/CN2019/071831

§ 371 Date: Sep. 26, 2019

(30) Foreign Application Priority Data
May 9, 2018 (CN) 201810439263.0

(51) Int. Cl. G06K 9/62; G06F 16/51; G06F 16/55

(52) U.S. Cl. CPC G06K 9/6223; G06K 9/6256; G06F 16/55; G06F 16/51; G06K 9/6215

(57) ABSTRACT

An image processing method includes acquiring a set of training images, and extracting a visual feature of each training image in the set of training images. The method includes clustering the visual feature, generating a visual dictionary composed of cluster centers serving as visual words, and adding 1 to the number of the visual dictionaries. The method includes determining whether the number of the visual dictionaries is equal to a predetermined number, and outputting the predetermined number of visual dictionaries generated if the determination result is yes, otherwise determining, from the visual dictionary, a visual word nearest to the visual feature. The method includes calculating a residual between the visual feature and the visual word nearest to the visual feature, determining the residual as the new visual feature, and returning to clustering the visual feature, generating a visual dictionary, and adding 1 to the number of the visual dictionaries.

### CROSS-REFERENCE TO RELATED APPLICATIONS

The present application is based on International Application No. PCT/CN2019/071831, filed on Jan. 15, 2019, which is based upon and claims priority to Chinese Patent Application No. 201810439263.0, filed on May 9, 2018, and the entire contents thereof are incorporated herein by reference.

### TECHNICAL FIELD

The present disclosure relates to the field of image processing technologies, and more particularly, to an image processing method, an image processing apparatus, an electronic device, and a computer-readable storage medium.

### BACKGROUND

Image retrieval technologies are widely used in pattern recognition, simultaneous localization and mapping (SLAM), and artificial intelligence, etc.

Basic concepts of the image retrieval technologies are as below. An image to be retrieved is provided, and then an image or a set of images similar to the image to be retrieved is retrieved from a specific image library. In existing image retrieval technologies such as image retrieval technologies based on a bag of words (BoW) model, when the scale of the image library becomes large, to increase the distinguishability of an image vector, generally a large number of visual words are required. In the image retrieval stage, it is needed to preload a visual dictionary composed of these visual words, which will greatly increase the memory footprint and make it difficult to meet the need of deploying at a mobile terminal.

Therefore, how to effectively reduce the scale of the visual words in the visual dictionary has become a technical problem to be solved urgently.

It is to be noted that the above information disclosed in this Background section is only for enhancement of understanding of the background of the present disclosure, and thus it may include information that does not constitute the prior art already known to those of ordinary skill in the art.

### SUMMARY

According to a first aspect of the arrangements of the present disclosure, there is provided an image processing method. The method includes acquiring a set of training images, and extracting a visual feature of each training image in the set of training images. The method includes clustering the visual feature, generating a visual dictionary composed of cluster centers serving as visual words, and adding 1 to the number of the visual dictionaries. The method includes determining whether the number of the visual dictionaries is equal to a predetermined number, and outputting the predetermined number of visual dictionaries generated if the determination result is yes, otherwise determining, from the visual dictionary, a visual word nearest to the visual feature. The method includes calculating a residual between the visual feature and the visual word nearest to the visual feature, determining the residual as the new visual feature, and returning to clustering the visual feature, generating a visual dictionary composed of cluster centers serving as visual words, and adding 1 to the number of the visual dictionaries.

In some arrangements of the present disclosure, based on the foregoing solution, the image processing method further includes extracting a visual feature of an image to be retrieved; determining, from the predetermined number of visual dictionaries, a plurality of visual words nearest to the visual feature of the image to be retrieved. The number of the plurality of visual words is equal to that of the visual dictionaries. The method further includes determining an index of the visual feature of the image to be retrieved based on indexes of the plurality of visual words.

In some arrangements of the present disclosure, based on the foregoing solution, the image processing method further includes determining an index of each visual feature of the training image based on the predetermined number of visual dictionaries. The method further includes determining a term frequency-inverse document frequency (TF-IDF) weight of the index of each visual feature of the training image. The method further includes generating a bag of words (BoW) vector of the training image based on the TF-IDF weight of the index of each of the visual features.

In some arrangements of the present disclosure, based on the foregoing solution, determining an index of each visual feature of the training image based on the predetermined number of visual dictionaries includes determining, from the predetermined number of visual dictionaries, a plurality of visual words nearest to the visual feature, the number of the plurality of visual words being equal to that of the visual dictionaries. The method further includes determining the index of the visual feature based on indexes of the plurality of visual words.

In some arrangements of the present disclosure, based on the foregoing solution, the image processing method further includes extracting a visual feature of an image to be retrieved. The method further includes determining a BoW vector of the visual feature of the image to be retrieved based on the predetermined number of visual dictionaries. The method further includes determining a similarity between the BoW vector of the image to be retrieved and the BoW vector of the training image. The method further includes outputting an image similar to the image to be retrieved based on a magnitude of the similarity determined.

In some arrangements of the present disclosure, based on the foregoing solution, determining a BoW vector of the visual feature of the image to be retrieved based on the predetermined number of visual dictionaries includes determining an index of each visual feature of the image to be retrieved based on the predetermined number of visual dictionaries. The method further includes determining a term frequency-inverse document frequency (TF-IDF) weight of the index of each visual feature of the training image. The method further includes generating the BoW vector of the image to be retrieved based on the TF-IDF weight of the index of each of the visual features.

In some arrangements of the present disclosure, based on the foregoing solution, the determining an index of each visual feature of the image to be retrieved based on the predetermined number of visual dictionaries includes determining, from the predetermined number of visual dictionaries, a plurality of visual words nearest to the visual feature of the image to be retrieved. The number of the plurality of visual words is equal to that of the visual dictionaries. The method further includes determining an index of the visual feature of the image to be retrieved based on indexes of the plurality of visual words.

According to a second aspect of the arrangements of the present disclosure, there is provided an image processing apparatus. The apparatus includes a first feature extraction unit, configured to acquire a set of training images, and extract a visual feature of each training image in the set of training images. The apparatus includes a clustering unit, configured to cluster the visual feature, generate a visual dictionary composed of cluster centers serving as visual words, and add 1 to the number of the visual dictionaries. The apparatus includes a determination unit, configured to determine whether the number of the visual dictionaries is equal to a predetermined number, and output the predetermined number of visual dictionaries generated if the determination result is yes. The apparatus includes a first visual word determination unit, configured to determine, from the visual dictionary, a visual word nearest to the visual feature. The apparatus includes a residual calculation unit, configured to calculate a residual between the visual feature and the visual word nearest to the visual feature, determine the residual as the new visual feature, and transmit the new visual feature to the clustering unit to cluster the same.

In some arrangements of the present disclosure, based on the foregoing solution, the image processing apparatus further includes a second feature extraction unit, configured to extract a visual feature of an image to be retrieved. The apparatus includes a second visual word determination unit, configured to determine, from the predetermined number of visual dictionaries, a plurality of visual words nearest to the visual feature of the image to be retrieved. The number of the plurality of visual words is equal to that of the visual dictionaries. The apparatus includes an index determination unit, configured to determine an index of the visual feature based on indexes of the plurality of visual words.

According to a third aspect of the arrangements of the present disclosure, there is provided an electronic device. The device includes: a processor; and a memory, storing computer-readable instructions thereon. The computer-readable instructions are executable by the processor, whereby the image processing method according to the first aspect is implemented.

According to a fourth aspect of the arrangements of the present disclosure, there is provided a computer-readable storage medium, storing a computer program thereon. The computer program is executable by the processor, whereby the image processing method according to the first aspect is implemented.

It is to be understood that both the foregoing general description and the following detailed description are example and explanatory only and are not restrictive of the present disclosure.

### BRIEF DESCRIPTION OF THE DRAWINGS

The accompanying drawings herein are incorporated in and constitute a part of this specification, illustrate arrangements conforming to the present disclosure and, together with the specification, serve to explain the principles of the present disclosure. Apparently, the accompanying drawings in the following description show merely some arrangements of the present disclosure, and persons of ordinary skill in the art may still derive other drawings from these accompanying drawings without creative efforts. In the drawings:

FIG. 1 illustrates a schematic diagram of an image histogram according to a technical solution;

FIG. 2 illustrates a flow diagram of an image processing method according to some arrangements of the present disclosure;

FIG. 3 illustrates a schematic diagram of indexing visual features from three visual dictionaries according to some arrangements of the present disclosure;

FIG. 4 illustrates a flow diagram of an image processing method according to some other arrangements of the present disclosure;

FIG. 5 illustrates a flow diagram of an image processing method according to still some other arrangements of the present disclosure;

FIG. 6 illustrates a schematic block diagram of an image processing apparatus according to an example arrangement of the present disclosure; and

FIG. 7 illustrates a schematic structural diagram of a computer system adapted to implement an electronic device according to an arrangement of the present disclosure.

### DETAILED DESCRIPTION

The example arrangement will now be described more fully with reference to the accompanying drawings. However, the example arrangements can be implemented in a variety of forms and should not be construed as limited to the arrangements set forth herein. Rather, these arrangements are provided so that the present disclosure will be thorough and complete and will fully convey the concepts of the example arrangements to those skilled in the art. The same reference numerals in the drawings denote the same or similar parts, and thus repeated description thereof will be omitted.

In addition, the features, structures, or characteristics described may be combined in one or more arrangements in any suitable manner. Many concrete details are provided in the following descriptions for a full understanding of arrangements of the present disclosure. However, those skilled in the art will appreciate that one or more of the specific details may be practiced without practicing the technical solutions of the present disclosure, and other methods, components, apparatuses, blocks, and the like may be employed. In other instances, well-known methods, apparatuses, implementations, or operations are not shown or described in detail to avoid obscuring aspects of the present disclosure.

The block diagrams illustrated in the drawings are merely functional entities and do not necessarily correspond to any physically separate entity. In other words, these functional entities may be implemented in software form, or implemented in one or more hardware modules or integrated circuits, or implemented in different networks and/or processor devices and/or microcontroller devices.

The flowcharts as shown in the accompanying drawings are merely example description instead of necessarily including all the contents and operations/blocks, or necessarily having to be performed in the order set forth. For example, some operations/blocks may be broken down, while some operations/blocks may be combined or partly combined. Therefore, the actual execution sequences may be changed according to the actual conditions.

A bag of words (BoW) model is an algorithm commonly used in the field of image retrieval. According to this algorithm, a local feature of a training image is first extracted and a feature descriptor of the local feature is constructed, and then the feature descriptor is clustered by training based on a clustering algorithm to generate a visual dictionary. Next, the visual feature is quantified by a K-Nearest Neighbor (KNN) algorithm, and finally an image histogram vector weighted by term frequency-inverse document frequency (TF-IDF) is obtained. The same method is used for an image to be retrieved to obtain an image histogram vector of the image to be retrieved, and it is determined whether the training image is similar to the image to be retrieved by way of distance calculation. The more the training image is similar to the image to be retrieved, the closer the distance between their histogram vectors is. A list of similar images is outputted based on the calculated distance between histogram vectors.

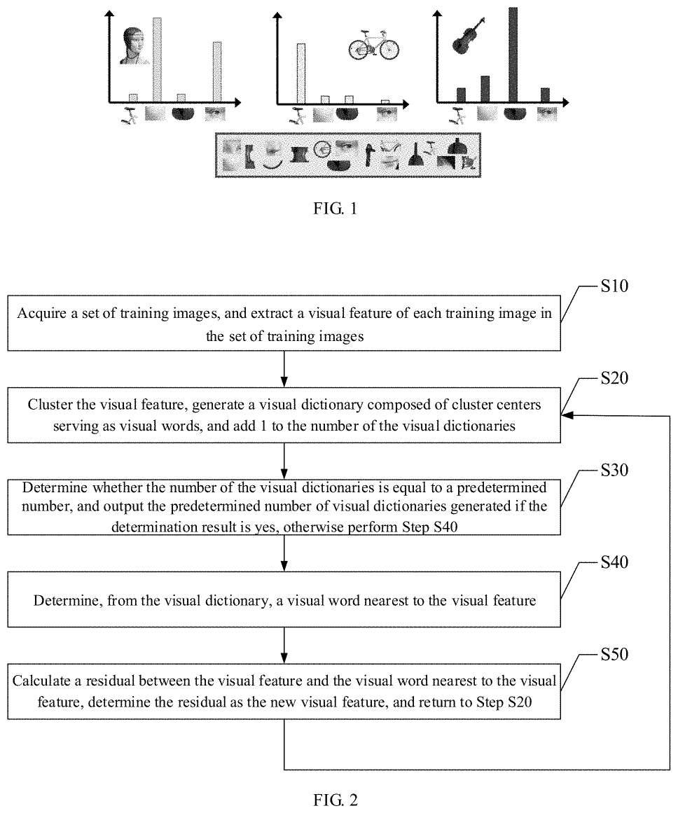

FIG. 1 illustrates a schematic diagram of an image histogram according to a technical solution. Referring to FIG. 1, for three images of human face, bicycle and guitar, similar features thereof are extracted (or similar features thereof are merged into the same type), and a visual dictionary is constructed, which contains four visual words, namely visual dictionary=(1. “Bicycle”, 2. “Human face”, 3. “Guitar”, 4. “Human face type”). Therefore, the three images of human face, bicycle and guitar may be represented by a 4-dimensional vector. Finally, the above corresponding histogram is drawn according to the number of occurrences of the corresponding features of the three images. In FIG. 1, histograms are generated for the three images according to four visual words, and similar images will have similar histogram vectors.

However, in the technical solution of the BoW model, to achieve better retrieval results, it is generally required to train a large-scale visual dictionary. A higher-efficiency visual dictionary may reach tens or even hundreds of megabytes of storage scale, which will greatly increase memory usage, making it difficult to meet the needs of deploying at a mobile terminal.

Based on the above contents, in an example arrangement of the present disclosure, first there is provided an image processing method. Referring to FIG. 2, the image processing method may include following blocks.

Block S10: acquiring a set of training images, and extracting a visual feature of each training image in the set of training images;

Block S20: clustering the visual feature, generating a visual dictionary composed of cluster centers serving as visual words, and adding 1 to the number of the visual dictionaries;

Block S30: determining whether the number of the visual dictionaries is equal to a predetermined number, and outputting the predetermined number of visual dictionaries generated if the determination result is yes, otherwise performing Block S40;

Block S40: determining, from the visual dictionary, a visual word nearest to the visual feature; and

Block S50: calculating a residual between the visual feature and the visual word nearest to the visual feature, determining the residual as the new visual feature, and returning to Block S20.

According to the image processing method in the example arrangement as shown in FIG. 2, in one aspect, a visual feature or a residual between the visual feature and a visual word is clustered to generate a visual dictionary composed of cluster centers serving as visual words, such that a predetermined number of parallel visual dictionaries of the same scale can be generated. In another aspect, any visual feature may simultaneously use the predetermined number of parallel visual dictionaries to index, such that the scale of the visual words in the visual dictionary can be significantly reduced, and the storage size of the visual dictionary can be significantly reduced, making it convenient to deploy at a mobile terminal.

The image processing method in the example arrangement as shown in FIG. 2 will be described in detail below.

In Block S10, a set of training images is acquired, and a visual feature of each training image in the set of training images is extracted.

In this example arrangement, a plurality of images are acquired from an image database of a server to serve as the set of training images. The images in the image database may include landscape images, figure images, commodity images, architecture images, animal images, and plant images, and the like, which are not particularly limited in the present disclosure.

Further, the corresponding visual feature of the training image may be extracted based on a Scale-Invariant Feature (SIFT) algorithm, a Speeded Up Robust Features (SURF) algorithm, or an Oriented FAST and Rotated BRIEF (ORB) algorithm. However, methods for extracting the visual feature of the training image of the present disclosure are not limited thereto. For example, a texture map feature, a histogram feature of oriented gradient, a color histogram feature and the like of the training image may also be extracted.

In Block S20, the visual feature is clustered, a visual dictionary composed of cluster centers serving as visual words is generated, and one is added to the number of the visual dictionaries.

In an example arrangement, visual features of training images may be clustered using clustering algorithms. The clustering algorithms may include K-means clustering and K-medoids clustering, but the arrangements of the present disclosure are not limited thereto. For example, the clustering algorithms may also include a hierarchical clustering algorithm and a density-based clustering algorithm, which are also within the scope of protection of the present disclosure.

Further, cluster centers of clusters obtained by clustering the visual features of the training images are used as visual words, and these visual words constitute a visual dictionary. For example, when the cluster center K is equal to 8, there are eight visual words, and the eight visual words constitute a visual dictionary. In the initial case, the number of the visual dictionaries may be set to 0, and the number of visual dictionaries is incremented by one each time a visual dictionary is generated.

In Block S30, it is determined whether the number of the visual dictionaries is equal to a predetermined number, and the predetermined number of visual dictionaries generated are outputted if the determination result is yes, otherwise Block S40 is performed.

In an example arrangement, the predetermined number of the visual dictionaries is set to M, and each time a visual dictionary is generated, it may be determined whether the number of the visual dictionaries is equal to M. When it is determined that the number of the visual dictionaries is equal to M, the M visual dictionaries generated are outputted. However, when it is determined that the number of the visual dictionaries is not equal to M, the next Block S40 is performed. An equal number of visual words are stored in each visual dictionary.

It is to be noted that the predetermined number M of the visual dictionaries may be determined according to factors such as the scale of the set of training images, the size of a memory, and the like. For example, when the scale of the set of training images is small and the memory is large, the predetermined number M may be set to 3.

In Block S40, a visual word nearest to the visual feature is determined from the visual dictionary.

In an example arrangement, the distance between a vector of the visual feature and a vector of each visual word in the visual dictionary may be calculated to obtain a visual word nearest to the visual feature. The distance between the visual feature and the visual word may be Hamming distance, Euclidean distance, or Cosine distance. However, the distance in the example arrangements of the present disclosure is not limited thereto. For example, the distance may also be Mahalanobis distance, Manhattan distance, and so on.

Next, in Block S50, a residual between the visual feature and the visual word nearest to the visual feature is calculated, the residual is determined as the new visual feature, and it is returned to Block S20.

In an example arrangement, a residual between the visual feature and the visual word nearest to the visual feature may be calculated, the calculated residual between the visual feature and the visual word nearest to the visual feature may be determined as the new visual feature, and it is returned to Block S20.

In Block S20, new visual features composed of residuals between visual features and visual words nearest to the visual features are clustered to generate a visual dictionary composed of cluster centers serving as visual words, and this operation is cycled until a predetermined number of visual dictionaries are obtained in Block S30.

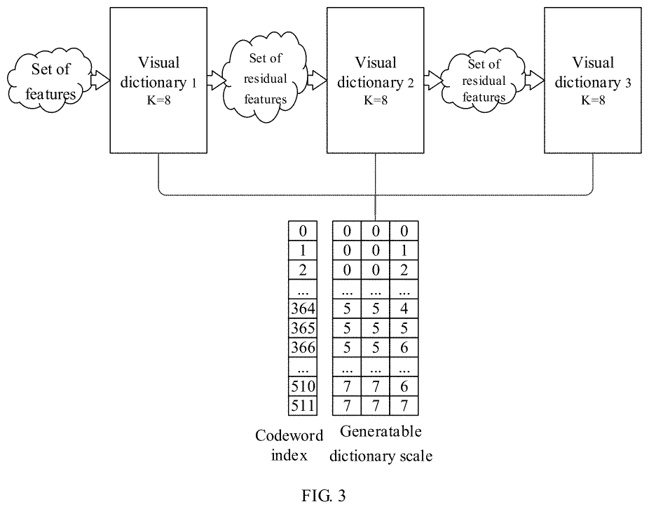

FIG. 3 illustrates a schematic diagram of indexing visual features from three visual dictionaries according to some arrangements of the present disclosure.

Referring to FIG. 3, K=8 visual words are stored in the visual dictionary 1, the visual dictionary 2, and the visual dictionary 3, respectively. The visual dictionary 1 is a visual dictionary obtained by clustering a set of visual features, and both the visual dictionary 2 and the visual dictionary 3 are visual dictionaries obtained by clustering a set of residual features composed of residuals between visual features and visual words nearest to the visual features in the previous visual dictionary.

When a visual feature is indexed, the index of the visual feature is sequentially acquired from the visual dictionary 1, the visual dictionary 2, and the visual dictionary 3, respectively. For example, the index of a visual word nearest to the visual feature obtained from the visual dictionary 1 is 5, a residual between the visual feature and the visual word nearest to the visual feature from the visual dictionary 1 is calculated, and the index of a visual word nearest to the residual obtained from the visual dictionary 2 is 5. The residual is determined as a new visual feature, a residual between the new visual feature and a visual word nearest to the visual feature from the visual dictionary 2 is calculated, and the index of a visual word nearest to this residual obtained from the visual dictionary 3 is 4. Thus, the final index of the visual feature obtained from the visual dictionary 1 to the visual dictionary 3 may be 554, which is equivalent to the index of the 365^{th} visual word in a visual dictionary, i.e., the final index of the visual feature is obtained by way of Cartesian product of the visual dictionaries.

Any visual feature may be indexed using M=3 visual words, and the index value of three visual dictionaries is K=8³=512, but the number of visual words to be stored in the three visual dictionaries is only K*M=24. Thus, compared with the case where only one visual dictionary is used, the storage size of the visual dictionaries is greatly reduced, making it convenient to deploy at a mobile terminal.

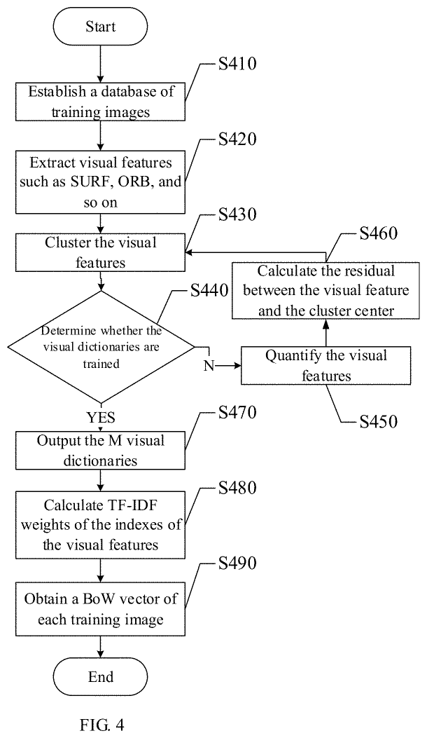

FIG. 4 illustrates a flow diagram of an image processing method according to some other arrangements of the present disclosure.

Referring to FIG. 4, in Block S410, a plurality of images are acquired as a set of training images, and a database of training images is established. For example, a plurality of images may be acquired from an image database of a server as the set of training images, and the database of training images may be established.

In Block S420, visual features of training images in the set of training images are extracted, for example, features such as scale-invariant features, speeded up robust features, color histogram features, or texture map features, etc.

In Block S430, the extracted visual features of the training images are clustered using a clustering algorithm, and cluster centers of clusters obtained by clustering are determined as visual words, which constitute a visual dictionary. The clustering algorithms may include K-means clustering and K-medoids clustering, but the arrangements of the present disclosure are not limited thereto. For example, the clustering algorithms may also include a hierarchical clustering algorithm and a density-based clustering algorithm, which are also within the scope of protection of the present disclosure.

In Block S440, it is determined whether the number of visual dictionaries has reached the predetermined number M. Block S470 is proceeded if the determination result is yes; otherwise, Block S450 is proceeded. The predetermined number M of the visual dictionaries may be determined according to factors such as the scale of the set of training images, the size of a memory, and the like. For example, when the scale of the set of training images is small and the memory is large, the predetermined number M may be set to 3.

In Block S450, the visual features extracted in Block S420 are quantified. That is, distances between the visual features and visual words in the visual dictionaries are calculated, such that a visual word nearest to the visual feature is determined. The distance between the visual feature and the visual word may be Hamming distance, Euclidean distance, or Cosine distance. However, the distance in the example arrangements of the present disclosure is not limited thereto. For example, the distance may also be Mahalanobis distance, Manhattan distance, and so on.

In Block S460, the residual between the visual feature and the visual word nearest to the visual feature is calculated, and the obtained residual between each visual feature and the visual word nearest to this visual feature is determined as a new visual feature, and the new visual feature is inputted to Block S430. In Block S430, a set of residuals composed of residuals between visual features and visual words are clustered to generate a new visual dictionary composed of cluster centers serving as new visual words, and this operation is cycled until a predetermined number of visual dictionaries are obtained in Block S440.

In Block S470, the M visual dictionaries trained in Block S440 are outputted. An equal number of visual words are stored in each visual dictionary.

In Block S480, indexes of visual features of the training images are determined based on the M visual dictionaries outputted in Block S470, and term frequency—inverse document frequency (TF-IDF) weights of the indexes of the visual features of the training images are counted up. That is, the TF-IDF weights of the indexes of the visual features are determined based on Cartesian product of the M visual dictionaries. Specifically, M visual words nearest to the visual features of the training images may be determined from the M visual dictionaries, the final indexes of the visual features are determined based on the indexes of the M visual words, and the TF-IDF weights of the final indexes of the visual features of the training images are counted up.

A term frequency of a visual feature reflects the number of times of appearance of the visual feature in the image, and an inverse document frequency of a visual feature reflects distinguishability of the visual feature upon the image. The larger the inverse document frequency is, the better the distinguishability of the visual feature upon the image is. The TF-IDF weight of a visual feature may be obtained by multiplying the term frequency of the visual feature by the inverse document frequency of the visual feature.

In Block S490, a BoW (Bag of words) vector of each training image is obtained based on the TF-IDF weight of the index of the visual feature of the training image. The TF-IDF weight of the index of each visual feature of the training image is recomposed into the BoW vector of the training image.

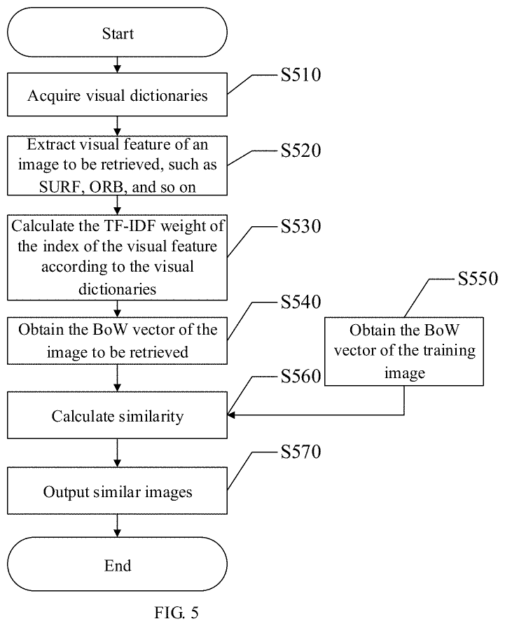

FIG. 5 illustrates a flow diagram of an image processing method according to still some other arrangements of the present disclosure.

Referring to FIG. 5, in Block S510, the M visual dictionaries outputted in the example arrangement of FIG. 1 are acquired.

In Block S520, visual features of an image to be retrieved are extracted, for example, features such as scale-invariant features, speeded up robust features, color histogram features, or texture map features, etc.

In Block S530, the TF-IDF weight of the index of the visual feature of the image to be retrieved is calculated according to the acquired M visual dictionaries. That is, the TF-IDF weight of the visual feature is determined by Cartesian product of the M visual dictionaries. For example, M visual words nearest to the visual feature of the training image may be sequentially determined from the M visual dictionaries, the final index of this visual feature is determined based on the indexes of the M visual words, and the TF-IDF weight of the final index of each visual feature of the training image is counted up.

In Block S540, the BoW vector of the image to be retrieved is obtained based on the TF-IDF weight of the index of each visual feature of the image to be retrieved.

In Block S550, the BoW vector of the training image generated in the above example arrangement is acquired.

In Block S560, a distance between the BoW vector of the image to be retrieved and the BoW vector of each training image is calculated, and similarity between the image to be retrieved and the training image is determined based on the calculated distance. The distance between the BoW vectors may be Hamming distance, Euclidean distance, or Cosine distance. However, the distance in the example arrangements of the present disclosure is not limited thereto. For example, the distance may also be Mahalanobis distance, Manhattan distance, and so on.

In Block S570, the training image where the similarity between the same and the image to be retrieved is greater than a predetermined threshold is outputted. That is, the image retrieval process is completed.

Further, a comparison between an algorithmic complexity of an original BoW model and an algorithmic complexity of a visual dictionary model having a tree structure is analyzed in Table 1 below using the method provided by the example arrangements of the present disclosure. Algorithm complexity analysis: BoW refers to the original BoW model, VT (Vocabulary Tree) refers to the visual dictionary model having a tree structure.

TABLE 1

| | | | Arrangements of |
|---|---|---|---|
| | | | the present |
| | BoW | VT | disclosure |
| Space | O(K^{M}D) | O(K^{M}D) | O(MKD) |
| complexity | | | |
| Time | O(K^{M}D) | O(MKD) | O(MKD) |
| complexity | | | |

Referring to Table 1, the space complexity of the original BoW model is the M^{th} order of K, and the time complexity of the original BoW model is the M^{th} order of K; and the space complexity of the visual dictionary having the tree structure is M^{th} order of K, and the time complexity of the visual dictionary having the tree structure is the linear order of K. Both the space complexity and the time complexity of the example arrangements of the present disclosure are the linear order of K. Therefore, according to the example arrangements of the present disclosure, the space complexity and the time complexity may be significantly reduced, and image processing efficiency may be improved.

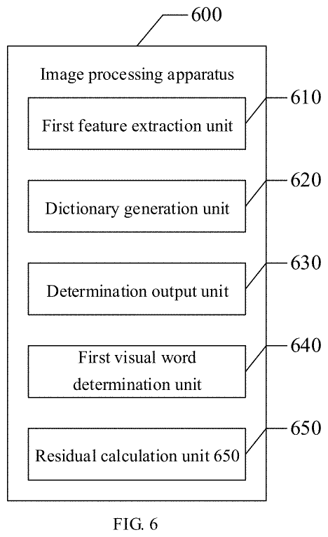

Moreover, in an arrangement of the present disclosure, there is also provided an image processing apparatus. Referring to FIG. 6, the image processing apparatus 600 may include: a first feature extraction unit 610, a dictionary generation unit 620, a determination output unit 630, a visual word determination unit 640, and a residual calculation unit 650. The feature extraction unit 610 is configured to acquire a set of training images, and extract a visual feature of each training image in the set of training images. The dictionary generation unit 620 is configured to cluster the visual feature, generate a visual dictionary composed of cluster centers serving as visual words, and add 1 to the number of the visual dictionaries. The determination output unit 630 is configured to determine whether the number of the visual dictionaries is equal to a predetermined number, and output the predetermined number of visual dictionaries generated if the determination result is yes. The first visual word determination unit 640 is configured to determine, from the visual dictionary, a visual word nearest to the visual feature. The residual calculation unit 650 is configured to calculate a residual between the visual feature and the visual word nearest to the visual feature, determine the residual as the new visual feature, and transmit the new visual feature to the clustering unit to cluster the same.

In some arrangements of the present disclosure, based on the foregoing solution, the image processing apparatus 600 further includes: a second feature extraction unit, configured to extract a visual feature of an image to be retrieved; a second visual word determination unit, configured to determine, from the predetermined number of visual dictionaries, a plurality of visual words nearest to the visual feature of the image to be retrieved, the number of the plurality of visual words being equal to that of the visual dictionaries; and an index determination unit, configured to determine an index of the visual feature of the image to be retrieved based on indexes of the plurality of visual words.

In some arrangements of the present disclosure, based on the foregoing solution, the image processing apparatus 600 further includes: a term frequency-inverse document frequency (TF-IDF) weight determination unit, configured to determine an index of each visual feature of the training image based on the predetermined number of visual dictionaries, and determine a TF-IDF weight of the index of each visual feature of the training image; and a bag of words (BoW) vector generation unit, configured to generate a BoW vector of the training image based on the TF-IDF weight of the index of each of the visual features.

In some arrangements of the present disclosure, based on the foregoing solution, the TF-IDF weight determination unit is configured to: determine, from the predetermined number of visual dictionaries, a plurality of visual words nearest to the visual feature, the number of the plurality of visual words being equal to that of the visual dictionaries; and determine the TF-IDF weight of the index of the visual feature.

In some arrangements of the present disclosure, based on the foregoing solution, the image processing apparatus 600 further includes: a third feature extraction unit, configured to extract a visual feature of an image to be retrieved; a BoW vector determination unit, configured to determine a BoW vector of the visual feature of the image to be retrieved based on the predetermined number of visual dictionaries; a similarity determination unit, configured to determine a similarity between the BoW vector of the image to be retrieved and the BoW vector of the training image; and an image output unit, configured to output an image similar to the image to be retrieved based on a magnitude of the similarity determined.

In some arrangements of the present disclosure, based on the foregoing solution, the BoW vector determination unit is configured to: determine an index of each visual feature of the image to be retrieved based on the predetermined number of visual dictionaries; determine a TF-IDF weight of the index of each visual feature of the training image; and generate the BoW vector of the image to be retrieved based on the TF-IDF weight of the index of each of the visual features.

In some arrangements of the present disclosure, based on the foregoing solution, the BoW vector determination unit is further configured to: determine, from the predetermined number of visual dictionaries, a plurality of visual words nearest to the visual feature of the image to be retrieved, the number of the plurality of visual words being equal to that of the visual dictionaries; and determine a TF-IDF weight of the index of the visual feature of the image to be retrieved based on indexes of the plurality of visual words.

Functional modules of the image processing apparatus 600 in this example arrangement of the present disclosure correspond to the blocks of the image processing method in the above example arrangement, and thus their detailed descriptions are omitted herein.

The first feature extraction unit, the dictionary generation unit, the determination output unit, the first visual word determination unit, the residual calculation unit, the second feature extraction unit, the second visual word determination unit and the index determination unit may be all stored as a program unit in a memory, and the processor executes the above-mentioned program unit stored in the memory to implement corresponding functions; or may be a chip that can implement the above-described operational blocks.

In an example arrangement of the present disclosure, there is further provided an electronic device capable of implementing the above method.

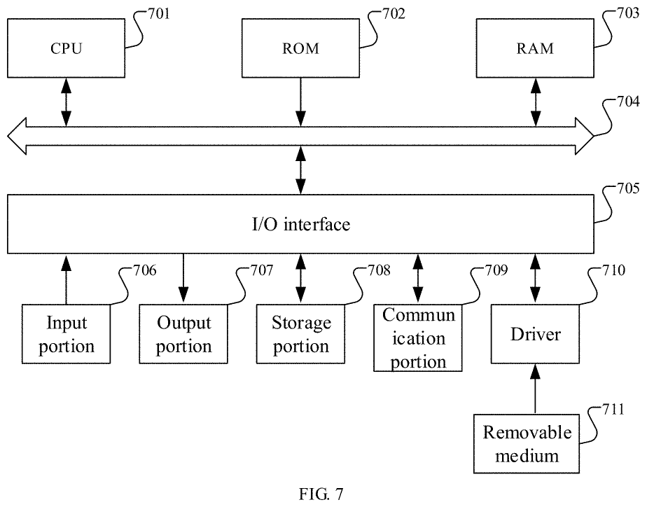

Referring to FIG. 7 below, a schematic structural diagram of a computer system 700 adapted to implement an electronic device of the arrangements of the present disclosure is shown. The computer system 700 of the electronic device as shown in FIG. 7 is merely an example, and no limitation should be imposed on functions or scope of use of the arrangements of the present disclosure.

As shown in FIG. 7, the computer system 700 includes a central processing unit (CPU) 701, which may execute various appropriate actions and processes in accordance with a program stored in a read-only memory (ROM) 702 or a program loaded into a random access memory (RAM) 703 from a storage portion 708. The RAM 703 also stores various programs and data required by operations of the system 700. The CPU 701, the ROM 702 and the RAM 703 are connected to each other through a bus 704. An input/output (I/O) interface 705 is also connected to the bus 704.

The following components are connected to the I/O interface 705: an input portion 706 including a keyboard, a mouse etc.; an output portion 707 including a cathode ray tube (CRT), a liquid crystal display device (LCD), a speaker etc.; a storage portion 708 including a hard disk and the like; and a communication portion 709 including a network interface card, such as a LAN card and a modem. The communication portion 709 performs communication processes via a network, such as the Internet. A driver 710 is also connected to the I/O interface 705 as required. A removable medium 711, such as a magnetic disk, an optical disk, a magneto-optical disk, and a semiconductor memory, may be installed on the driver 710, to facilitate the retrieval of a computer program from the removable medium 711, and the installation thereof on the storage portion 708 as needed.

In particular, according to an arrangement of the present disclosure, the process described above with reference to the flow chart may be implemented in a computer software program. For example, an arrangement of the present disclosure includes a computer program product, which includes a computer program that is tangibly embedded in a computer-readable medium. The computer program includes program codes for executing the method as illustrated in the flowchart. In such an arrangement, the computer program may be downloaded and installed from a network via the communication portion 709, and/or may be installed from the removable media 711. The computer program, when executed by the CPU 701, implements the functions as defined by the system of the present disclosure.

It is to be noted that the computer-readable medium shown in the present disclosure may be a computer-readable signal medium or a computer-readable storage medium, or any combination thereof. The computer-readable storage medium may be, for example, but not limited to, an electronic, magnetic, optical, electromagnetic, infrared, or semiconductor system, apparatus, or device, or any combination of the foregoing. More specific examples of the computer-readable storage medium may include, but not limited to: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, the computer-readable storage medium may be any tangible medium that can contain or store a program for use by or in connection with an instruction execution system, apparatus, or device. However, in the present disclosure, the computer-readable signal medium may include a propagated data signal with computer-readable program code embodied therein, for example, in baseband or as part of a carrier wave. Such a propagated data signal may take any of a variety of forms, including, but not limited to, electro-magnetic, optical, or any suitable combination thereof. The computer-readable signal medium also may be any computer-readable medium that is not a computer-readable storage medium and that can transmit, propagate, or transport a program for use by or in connection with an instruction execution system, apparatus, or device. Program code embodied on the computer-readable medium may be transmitted using any appropriate medium, including but not limited to wireless, wireline, optical fiber cable, RF, etc., or any suitable combination of the foregoing.

The flowcharts and block diagrams in the figures illustrate architectures, functions and operations that may be implemented according to the system, the method and the computer program product of the various arrangements of the present disclosure. In this regard, each block in the flow charts and block diagrams may represent a module, a program segment, or a code portion. The module, the program segment, or the code portion includes one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams or the flowcharts and/or a combination of the blocks in the block diagrams or the flowcharts may be implemented by a dedicated hardware-based system executing specified functions or operations, or by a combination of a dedicated hardware and computer instructions.

The units involved in the descriptions of the arrangements of the present disclosure may be implemented by way of software or hardware, and the described units also may be arranged in a processor. The names of these units are not considered as a limitation to the units.

In another aspect, the present disclosure further provides a computer-readable medium. The computer-readable medium may be the medium included in the electronic device described in the above arrangements, or a stand-alone medium which has not been assembled into the electronic device. The above computer-readable medium carries one or more programs. The one or more programs are executable by the electronic device, whereby the electronic device is caused to implement the image processing method as recited in the above arrangements.

For example, as shown in FIG. 1 the electronic device may be configured to: block S10: acquire a set of training images, and extract a visual feature of each training image in the set of training images; block S20: cluster the visual feature, generate a visual dictionary composed of cluster centers serving as visual words, and add 1 to the number of the visual dictionaries; block S30: determine whether the number of the visual dictionaries is equal to a predetermined number, and output the predetermined number of visual dictionaries generated if the determination result is yes, otherwise perform Block S40; block S40: determine, from the visual dictionary, a visual word nearest to the visual feature; and block S50: calculate a residual between the visual feature and the visual word nearest to the visual feature, determine the residual as the new visual feature, and return to Block S20.

It is to be noticed that although a plurality of modules or units of a device or an apparatus for action execution have been mentioned in the above detailed description, this partition is not compulsory. Actually, according to the arrangements of the present disclosure, features and functions of two or more modules or units as described above may be embodied in one module or unit. Reversely, features and functions of one module or unit as described above may be further embodied in more modules or units.

With description of the above arrangements, it will be readily understood by those skilled in the art that the example arrangements described herein may be implemented by software or may be implemented by means of software in combination with the necessary hardware. Thus, the technical solution according to the arrangements of the present disclosure may be embodied in the form of a software product which may be stored in a nonvolatile storage medium (which may be CD-ROM, USB flash disk, mobile hard disk and the like) or on network, including a number of instructions for enabling a computing device (which may be a personal computer, a server, a touch terminal, or a network device and the like) to perform the method according to the arrangements of the present disclosure.

Other arrangements of the present disclosure will be apparent to those skilled in the art from consideration of the specification and practice of the present disclosure disclosed here. The present disclosure is intended to cover any variations, uses, or adaptations of the present disclosure following the general principles thereof and including such departures from the present disclosure as come within known or customary practice in the art. It is intended that the specification and examples be considered as example only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof.

1. An image processing method comprising:
acquiring a set of training images, and extracting a visual feature of each the set of training images;
clustering the visual feature, generating visual dictionaries composed of cluster centers serving as visual words, and adding one to a number of the generated visual dictionaries;
determining whether the number of the visual dictionaries is equal to a predetermined number, and outputting the predetermined number of visual dictionaries being generated if the determination is yes, otherwise performing;
determining, from the visual dictionaries, a visual word nearest to the visual feature; and
calculating a residual between the visual feature and the visual word nearest to the visual feature, determining the residual as a new visual feature, and returning to.

2. The image processing method according to claim 1 further comprising:
extracting a second visual feature of an image to be retrieved;
determining, from the predetermined number of visual dictionaries, a plurality of visual words nearest to the second visual feature of the image to be retrieved, the number of the plurality of visual words being equal to that of the visual dictionaries; and
determining an index of the second visual feature of the image to be retrieved based on indexes of the plurality of visual words.

3. The image processing method according to claim 1 further comprising:
determining an index of the visual feature of each of the set of training images based on the predetermined number of visual dictionaries;
determining a term frequency-inverse document frequency (TF-IDF) weight of the index of the visual feature of each of the set of training images; and
generating a bag of words (BoW) vector of the training images based on the TF-IDF weight of the index of the visual feature.

4. The image processing method according to claim 3, wherein determining an index of each visual feature of the training image based on the predetermined number of visual dictionaries further comprises:
determining, from the predetermined number of visual dictionaries, a plurality of visual words nearest to the visual feature, the number of the plurality of visual words being equal to that of the visual dictionaries; and
determining the index of the visual feature based on indexes of the plurality of visual words.

5. The image processing method according to claim 3 further comprising:
extracting a third visual feature of an image to be retrieved;
determining a BoW vector of the third visual feature of the image to be retrieved based on the predetermined number of visual dictionaries;
determining a similarity between the BoW vector of the image to be retrieved and the BoW vector of the training image; and
outputting an image similar to the image to be retrieved based on a magnitude of the similarity determined.

6. The image processing method according to claim 5, wherein determining a BoW vector of the third visual feature of the image to be retrieved based on the predetermined number of visual dictionaries further comprises:
determining an index of the third visual feature of the image to be retrieved based on the predetermined number of visual dictionaries;
determining a term frequency-inverse document frequency (TF-IDF) weight of the index of the third visual feature of the training image; and
generating the BoW vector of the image to be retrieved based on the TF-IDF weight of the index of the third visual feature.

7. The image processing method according to claim 6, wherein determining an index of the third visual feature of the image to be retrieved based on the predetermined number of visual dictionaries further comprises:
determining, from the predetermined number of visual dictionaries, a plurality of visual words nearest to the third visual feature of the image to be retrieved, the number of the plurality of visual words being equal to that of the visual dictionaries; and
determining an index of the third visual feature of the image to be retrieved based on indexes of the plurality of visual words.

8. The image processing method according to claim 1, wherein each of the visual dictionaries comprises n equal number of visual words.

9. An image processing apparatus, comprising:
a first feature extraction unit, configured to acquire a set of training images, and extract a visual feature of each training image in the set of training images;
a dictionary generation unit, configured to cluster the visual feature, generate visual dictionaries composed of cluster centers serving as visual words, and add one to a number of the visual dictionaries;
a determination output unit, configured to determine whether the number of the visual dictionaries is equal to a predetermined number, and output the predetermined number of visual dictionaries generated if the determination is yes;
a first visual word determination unit, configured to determine, from a visual dictionary, a visual word nearest to the visual feature; and
a residual calculation unit, configured to calculate a residual between the visual feature and the visual word nearest to the visual feature, determine the residual as the new visual feature, and transmit a new visual feature to the dictionary generation unit to cluster the same.

10. The image processing apparatus according to claim 9 further comprising:
a second feature extraction unit, configured to extract a second visual feature of an image to be retrieved;
a second visual word determination unit, configured to determine, from the predetermined number of visual dictionaries, a plurality of visual words nearest to the second visual feature of the image to be retrieved, the number of the plurality of visual words being equal to that of the visual dictionaries; and
an index determination unit, configured to determine an index of the second visual feature based on indexes of the plurality of visual words.

11. An electronic device, comprising:
a processor; and
a memory, storing computer-readable instructions thereon, wherein the computer-readable instructions are executable by the processor, whereby the image processing method according to claim 1 is implemented.

12. A computer-readable storage medium, storing a computer program thereon, wherein the computer program is executable by a processor, whereby the image processing method according to claim 1 is implemented.

13. The image processing method according to claim 4 further comprising:
extracting a fourth visual feature of an image to be retrieved;
determining a BoW vector of the fourth visual feature of the image to be retrieved based on the predetermined number of visual dictionaries;
determining a similarity between the BoW vector of the image to be retrieved and the BoW vector of the training image; and
outputting an image similar to the image to be retrieved based on a magnitude of the similarity determined.

14. An electronic device, comprising:
a processor; and
a memory, storing computer-readable instructions thereon, wherein the computer-readable instructions are executable by the processor, whereby the image processing method according to claim 2 is implemented.

15. An electronic device, comprising:
a processor; and
a memory, storing computer-readable instructions thereon, wherein the computer-readable instructions are executable by the processor, whereby the image processing method according to claim 3 is implemented.

16. An electronic device, comprising:
a processor; and
a memory, storing computer-readable instructions thereon, wherein the computer-readable instructions are executable by the processor, whereby the image processing method according to claim 4 is implemented.

17. A computer-readable storage medium, storing a computer program thereon, wherein the computer program is executable by a processor, whereby the image processing method according to claim 2 is implemented.

18. A computer-readable storage medium, storing a computer program thereon, wherein the computer program is executable by a processor, whereby the image processing method according to claim 3 is implemented.

19. A computer-readable storage medium, storing a computer program thereon, wherein the computer program is executable by a processor, whereby the image processing method according to claim 4 is implemented.

20. A computer-readable storage medium, storing a computer program thereon, wherein the computer program is executable by a processor, whereby the image processing method according to claim 5 is implemented.
